(19) United States
(12) Patent Application Publication
(10) Pub. No.: US 2008/0071514 A1
(43) Pub. Date: Mar. 20, 2008

(54) Apparatus for handling register-transfer-level description, method thereof, and program storage medium storing program thereof

(75) Inventor: Eisuke Yuri, Fukuoka-Shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/894,353

(22) Filed: Aug. 21, 2007

(30) Foreign Application Priority Data
Sep. 20, 2006 (JP) 2006-254653

(51) Int. Cl. G06F 17/50

(52) U.S. Cl. 703/15

(57) ABSTRACT

A circuit description is separated into sequential-circuit descriptions as a sequential-circuit-description part and combinational-circuit descriptions as a combinational-circuit-description part. The sequential-circuit-description part is modified and converted into combinational-circuit descriptions. A simulation description is configured with the combinational-circuit-description part and the combinational-circuit descriptions converted from the sequential-circuit-description part. This arrangement can generate a simulation description that does not contain a sequential-circuit description requiring an arithmetic operation at each clock event and that allows the number of arithmetic operations to be reduced. This is because, during simulation, the arithmetic operation is triggered by an update of input variables other than a clock, rather than being triggered by a clock event.

### BACKGROUND OF THE INVENTION

1. Field of the Invention

In general, in circuit design and verification of hardware, such as large-scale integrated (LSI) circuits and field programmable gate arrays (FPGAs), a model referred to a register transfer level (RTL) model described in a hardware-description language (HDL) is used. An RTL model typically includes combinational circuits allocated alternately with sequential circuits which operate in synchronization with clock events. An HDL is a language designed especially for describing hardware. The present invention relates to a technology for converting the contents of an RTL description in order to execute a simulation of an RTL model at higher speed.

2. Description of the Related Art

Before fabricating hardware, such as LSI circuits or FPGAs, developers create a simulation model (i.e., an RTL model) that is executable on a computer and perform a simulation to check whether or not the model operates properly. Today's large-scale circuits may require several months for a simulation. This leads to an increase in the design period, thus causing a delay in the introduction of products to the market.

Japanese Unexamined Patent Application Publication No. 6-96157 (Patent Document 1) discloses a conversion method for a state transition description written in a hardware-description language, with an aim to enhance the design efficiency.

The state-transition-description conversion method of the related art includes a first step of extracting a logical-expression part for hardware description, and a second step of separating the extracted logical-expression part into a first module part and a second module part. The first module part contains fixed circuit parts that are irrelevant to a state transition of the circuit, and the second module part contains circuit parts that are described in another hardware-description language and that are relevant to the state transition of the circuit. The conversion method further includes a third step of generating a first circuit module by optimizing the circuit configuration of the first module portion, a fourth step of assigning a predetermined state to the second module portion and generating a second circuit module that uses a predetermined signal sent from the first circuit module as an input signal for the state transition, a fifth step of synthesizing a final circuit by using the first circuit module and the second circuit module, and a sixth step of determining whether the synthesis of the final circuit is appropriate or not. In the sixth step, when the synthesis is appropriate, the processing is finished, and when re-synthesis is to be performed, a state that is different from the predetermined state is assigned and the fourth and subsequent steps are repeatedly executed.

Thus, according to the state-transition-description conversion method of the related art, an intended circuit is separated into fixed circuit parts that are irrelevant to state assignment and circuit parts that are relevant to the state assignment, and another HDL for the circuit parts that are relevant to the state assignment is used to execute re-synthesizing processing, such as state assignment. This method can significantly increase the processing speed, i.e., significantly reduce the turn-around time.

In order to address the above-described problem of the increase in the design period, a simulation based on a description in a high-level language may be performed independently from the simulation of an RTL model. Only circuit behavior is described in such a high-level language. In such a case, after the simulation based on a description in a high-level language such as a C-language is performed to check the validity of the circuit behavior, an RTL model that performs an arithmetic operation equivalent to the C-language model is created to perform a simulation. Since the C-language model can be simulated about 1000 times faster than the RTL model, it is possible to detect and modify an abnormality in the behavior in a short period of time. Thus, creation of an RTL model while referring to the C-language model makes it possible to reduce the likelihood of failure occurrence. However, since an RTL model that is manually created can contain a failure, a simulation for the RTL model cannot be eliminated.

On the other hand, a technology called “behavioral synthesis” (or “high-level synthesis”) may be used to automatically generate an RTL model from a C-language model. However, the behavioral-synthesis technology has a problem of that the circuit scale increases compared to a manually created RTL model, and thus is not commonly used. Even if the behavioral-synthesis technology is used, it is necessary to confirm that a C-language model and an RTL model are logically equal to each other.

In theory, if the behavioral-synthesis technology (or a behavioral-synthesis tool) completely ensures the equality of a C-language model and an RTL model, it is unnecessary to simulate an RTL model that is automatically output from the behavioral-synthesis tool. In practice, however, since any behavioral-synthesis tool is not perfect, another means must be used to ensure the equality. As the other means, the simulation of the RTL model is still required. Thus, the use of the behavioral-synthesis technology does not contribute to a reduction in the design period. It is, therefore, necessary to simulate the RTL model at high speed by using some kind of method.

The state-transition-description conversion method disclosed in Patent Document 1 described above is also one example of behavioral synthesis. The method conversion allows the design period to be reduced by an amount corresponding to a decrease in the amount of designer work. The method conversion described in Patent Document 1, however, needs to directly perform a simulation on a created RTL; thus, it is impossible to solve the problem of requiring a large amount of time for simulation.

An RTL model expresses an operation of an actual circuit in a pseudo manner. During simulation, a simulator properly computes and stores how the circuit operates, in response to changes in signals that are sequentially generated in the RTL model. Thus, when the operation of the RTL model is complicated or changes in signal values are significant, the number of arithmetic operations (i.e., load) of the simulator increases extremely. This results in a significant increase in the simulation time.

In the RTL-model description format, a sequential-circuit description is written so as to operate in synchronization with each clock rising or falling (which will be referred to as a “clock event”). FIG. 1 is a schematic diagram illustrating the operation of a sequential-circuit description. The simulator performs an arithmetic operation with input data 14 at each clock event 12, and generates output data 16. As shown in FIG. 1, even when input data 14 for the sequential-circuit description does not change, the simulator performs the arithmetic operation at each clock event 12. This makes wasteful processing 22 in the simulation and is a cause of a reduction in the simulation speed.

### SUMMARY OF THE INVENTION

The present invention has been conceived in order to solve the problems described above, and an object of the present invention is to provide a high-speed hardware-simulation-model generation device that converts a model written in a hardware-description language into a simulation description to execute a simulation at high speed.

A combinational-circuit description is the most essential part of an RTL description and describes a genuine algorithm. A combinational-circuit description does not involve any clock. Thus, the simulator executes processing in response to only changes in data input to the combinational circuit, and thus does not perform any wasteful processing.

In a synchronization system having a sequential circuit, the number of changes in data is extremely small compared to the number of clock events. The present invention utilizes this feature of the synchronization system. That is, in the present invention, of an RTL description, a sequential-circuit description that operates in synchronization with a clock is modified and converted into a combinational-circuit description that reacts to only a change in data. A model generated according to the present invention does not involve any wasteful arithmetic operation based on a clock event, and thus allows a simulation to be executed at higher speed than the known RTL model.

FIG. 2 is an example of an RTL description before the present invention is applied. For example, even when a simple arithmetic operation such as “in1+in2” is performed, the description of an RTL model becomes complicated as shown in FIG. 2. This is because it is necessary to ensure that an actual circuit, after the RTL model is logically synthesized, operates as intended by the developer. As described above, the simulation time increases as the description of the RTL model becomes more complicated. In particular, when the number of sequential-circuit descriptions that are to be subjected to arithmetic operation at each clock event is large, the simulation speed decreases significantly. FIG. 3 is an example of a simulation description obtained by performing a conversion on the RTL description shown in FIG. 2 according to the present invention. This description shown in FIG. 3 will hereinafter be referred to as a “simulation description”. This simulation description is obtained by removing a sequential-circuit-description synchronization part that is irrelevant to a function and extracting only the essential arithmetic operations “in1+in2”. This simulation description allows a simulation to be executed at higher speed than the RTL description shown in FIG. 2.

The present invention pays attention to the fact that an RTL model contains sequential-circuit descriptions and combinational-circuit descriptions. FIG. 4 shows the structure of a typical RTL model. Sequential-circuit descriptions 32 operate in synchronization with clock events 36. On the other hand, combinational-circuit descriptions 34 do not depend on clock events 36, and perform processing in response to changes in data input to the combinational-circuit descriptions 34.

When written in a hardware-description language, the sequential-circuit descriptions 32 and the combinational-circuit descriptions 34 are expressed in “process” statements in VHDL (very high-speed integrated circuit hardware-description language) and in “always” statements in Verilog-HDL.

In view of the foregoing, the present invention will now be described in conjunction with aspects thereof.

One aspect of the present invention provides an apparatus which handles a register-transfer-level description. The register-transfer-level description is described in a hardware-description language and includes a sequential-circuit description in which a sequential circuit is described. The sequential circuit has a configuration which is capable of executing a processing which is triggered by a clock event. The apparatus includes a circuit separator, a sequential-circuit modifier, and a simulation describer. The circuit separator separates the register-transfer-level description into a sequential-circuit-description part and a combinational-circuit-description part. The sequential-circuit-description part includes the sequential-circuit description. The combinational-circuit-description part does not include the sequential-circuit description. The sequential-circuit modifier converts the sequential-circuit description which is included in the sequential-circuit-description part into a combinational-circuit description in which a combinational circuit is described. The combinational-circuit has a configuration which is capable of executing a processing which is triggered by an update of an input variable other than a clock variable. The simulation describer configures a simulation description by coupling the combinational-circuit-description part and the combinational-circuit description which is converted from the sequential-circuit description which is included in the sequential-circuit-description part.

The apparatus according to the present invention may further include a circuit-description checker which checks the register-transfer-level description as to whether a block name is given to a block statement which is included in the register-transfer-level description before the circuit separator separates the register-transfer-level description, and issues a warning when it detects a block statement which is not given a block name.

The apparatus according to the present invention may further include a delay adder which adds a delay time to an arithmetic expression which is included in the combinational-circuit description which is converted from the sequential-circuit description which is included in the sequential-circuit-description part.

The apparatus according to the present invention may further include an optimizer which replaces a combinational-circuit description with an assignment statement. The combinational-circuit description is included in the simulation description which is configured by the simulation describer. The assignment statement is included in the combinational-circuit description.

The apparatus according to the present invention may further include a sequential-circuit detector which detects the sequential-circuit description among from circuit descriptions on the basis of conditional branching which is included in the circuit descriptions before the circuit separator separates the register-transfer-level description. The circuit descriptions are included in the register-transfer-level description.

The apparatus according to the present invention may further include a simulation executor which executes a circuit simulation on the basis of the simulation description which is configured by the simulation describer.

The sequential-circuit modifier in the apparatus according to the present invention may remove a clock-event-detection part from the sequential-circuit description. A description for detecting a clock event is described in the clock-event-detection part.

Another aspect of the present invention provides a method which is executed by an apparatus for handling a register-transfer-level description. The register-transfer-level description is described in a hardware-description language and includes a sequential-circuit description in which a sequential circuit is described. The sequential-circuit has a configuration which is capable of executing a processing which is triggered by a clock event. The method includes: The step in which the register-transfer-level description is separated into a sequential-circuit-description part and a combinational-circuit-description part. The sequential-circuit-description part includes the sequential-circuit description. The combinational-circuit-description part does not include the sequential-circuit description; The step in which the sequential-circuit description which is included in the sequential-circuit-description part is converted into a combinational-circuit description in which a combinational circuit is described. The combinational-circuit has a configuration which is capable of executing a processing which is triggered by an update of an input variable other than a clock variable; and The step in which a simulation description is configured by coupling the combinational-circuit-description part and the combinational-circuit description which is converted from the sequential-circuit description which is included in the sequential-circuit-description part.

Still another aspect of the present invention provides a program storage medium readable by a computer. The program storage medium stores a program of instructions for the computer to execute method steps of the method mentioned above for handling a RTL description.

The above-described overviews of the present invention do not necessarily represent essential features of the present invention, and some of those features may also be combined to implement the present invention.

As described above, according to the present invention, of a sequential-circuit description, a part that operates in synchronization with a clock is modified and converted into a combinational-circuit description and a delay is added thereto in order to reduce the load of the simulator. As a result, it is possible to increase the simulation speed while maintaining a result and output timing that are the same as the result and the output timing of an original RTL model. This makes it possible to prevent an increase in a development period.

### BRIEF DESCRIPTION OF THE DRAWINGS

FIG. 1 is a schematic diagram illustrating the operation of a sequential-circuit description;

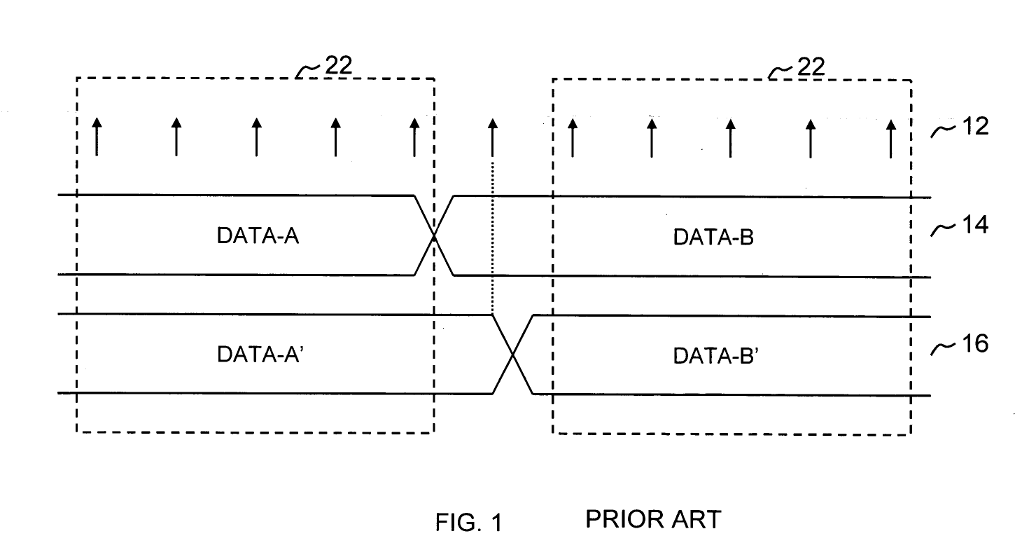

FIG. 2 is an example of an RTL description before the present invention is applied;

FIG. 3 is an example of a simulation description obtained by performing a conversion according to the present invention on the RTL description shown in FIG. 2;

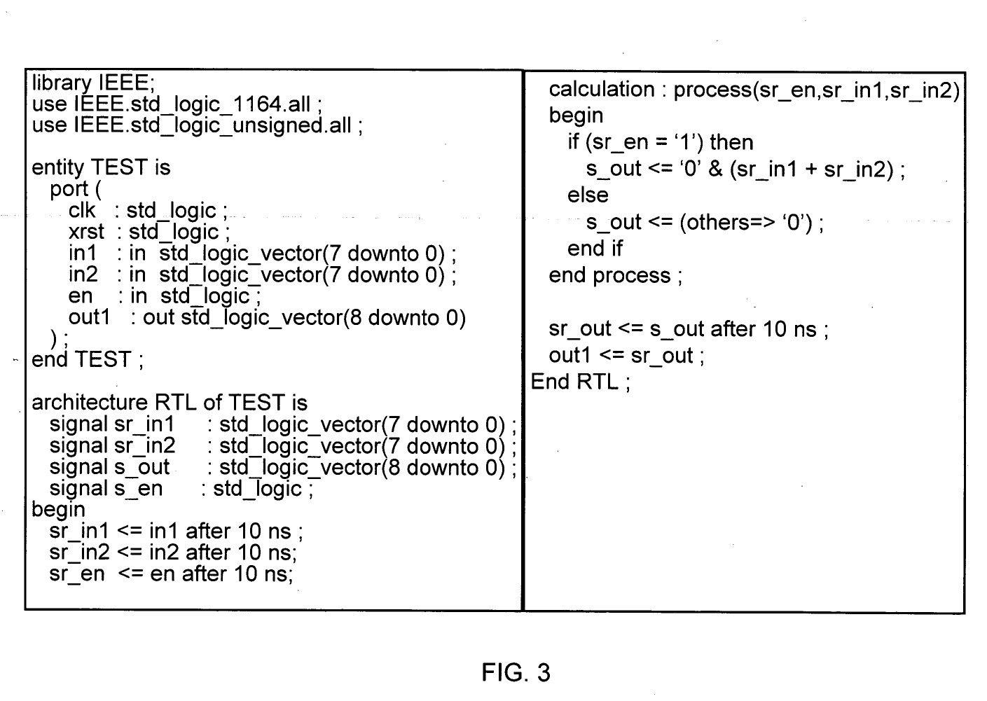

FIG. 4 shows the structure of a typical RTL model;

FIG. 5 is a block diagram of a simulation apparatus according to the present invention;

FIG. 6A is an example of a sequential-circuit description;

FIG. 6B shows a combinational-circuit description converted from the sequential-circuit description shown in FIG. 6A by sequential-circuit modifier;

FIG. 7A is an example of a combinational-circuit description after a delay is added;

FIG. 7B shows a result obtained by executing optimizer;

FIG. 8 shows the structure of a simulation description obtained by performing the conversion according to present invention on the typical RTL model shown in FIG. 4;

FIG. 9 is a flowchart of a simulation apparatus according to a first embodiment of the present invention:

FIG. 10 is a flowchart of circuit-description checker according to the first embodiment of the present invention;

FIG. 11 is a flowchart of a simulation apparatus further including processing performed by delay adder according to the first embodiment of the present invention;

FIG. 12 is a flowchart of a simulation apparatus further including pre-processing for realizing optimizer according to the first embodiment of the present invention;

FIG. 13 is a flowchart of optimizer according to the first embodiment of the present invention;

FIG. 14 is a flowchart of sequential-circuit detector according to a second embodiment of the present invention;

FIG. 15A illustrates processing of leaving reset-event processing;

FIG. 15B shows a structure of an RTL description;

FIG. 15C shows a structure of a sequential-circuit-description block in the RTL description;

FIG. 15D shows a structure of the sequential-circuit-description block after modified in the first embodiment of the present invention; and

FIG. 15E shows a structure of the sequential-circuit-description block after modified in a third embodiment of the present invention.

### DESCRIPTION OF THE PREFERRED EMBODIMENTS

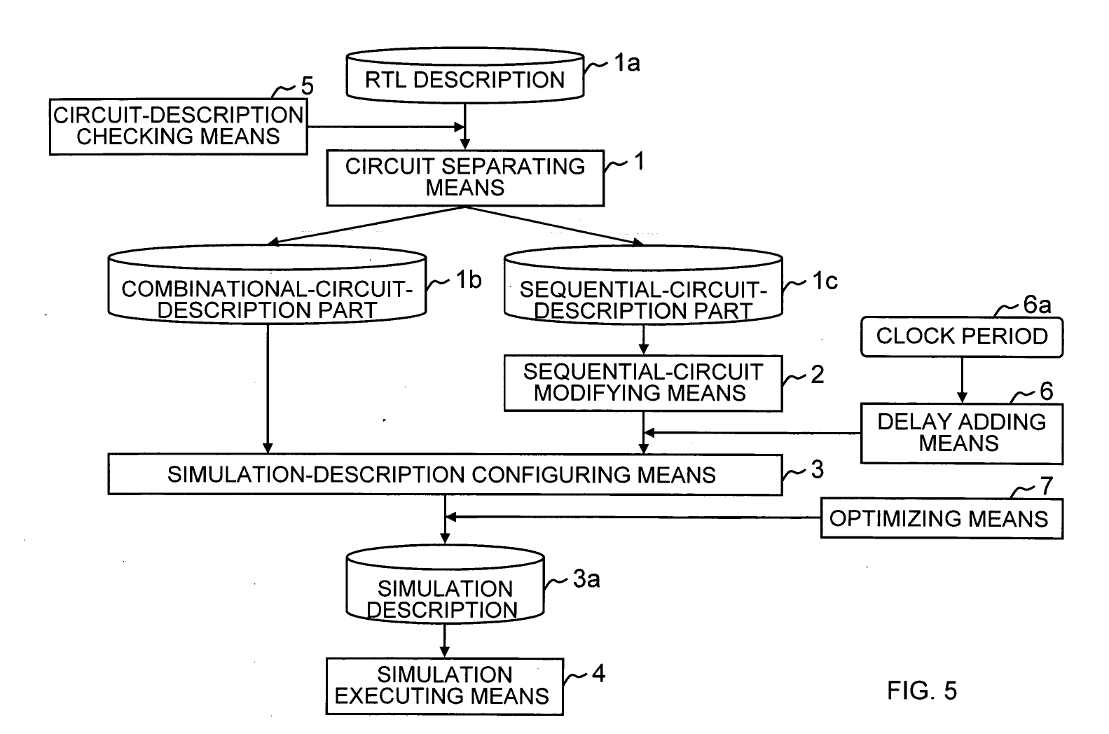

An overview of the present invention will first be described. FIG. 5 is a block diagram of a simulation apparatus according to the present invention. In FIG. 5, upon receiving an RTL description 1a, circuit separator 1 separates the RTL description 1a into sequential-circuit descriptions as a sequential-circuit-description part 1c and combinational-circuit descriptions as a combinational-circuit-description part 1b. Sequential-circuit modifier 2 is a feature of the present invention, and modifies and converts the sequential-circuit-description part 1c into combinational-circuit descriptions. Simulation describer 3 integrates the combinational-circuit-description part 1b with the result of the sequential-circuit modifier 2 and outputs a simulation description 3a. Upon receiving the simulation description 3a, simulation executor 4 executes a simulation. The simulation executor 4 may be the so-called “HDL simulator”. Circuit-description checker 5 checks a description format of the RTL description 1a so as to allow the circuit separator 1 to efficiently perform processing, and determines whether or not a block name (i.e., a label for a “process” statement in VHDL or an “always” statement in Verilog-HDL) is given to the RTL description 1a. Delay adder 6 is another feature of the present invention, and adds a delay time corresponding to a clock period 6a. Optimizer 7 removes a redundant part to optimize a combinational-circuit description resulting from the simulation describer 3, thereby making it possible to increase the simulation speed.

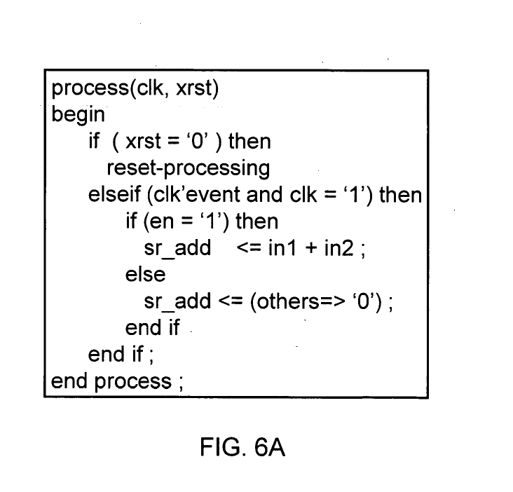

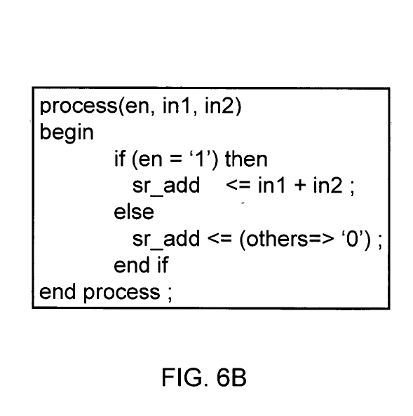

In the present invention, the circuit separator 1 shown in FIG. 5 separates the RTL description 1a into the sequential-circuit-description part 1c and the combinational-circuit-description part 1b. Next, the sequential-circuit modifier 2 removes a clock-event-detection part and other unwanted parts, which are factors of reducing the simulation speed, from the sequential-circuit-description part 1c. FIGS. 6A and 6B show an effect of the sequential-circuit modifier 2. FIG. 6A is an example of a sequential-circuit description. Of the RTL description 1a, only a part written as a sequential-circuit description is shown in FIG. 6A. In operation, for “en”=‘1’, “in1” and “in2” are added to each other and the result thereof is assigned to a signal “sr_add”. For “en”=‘0’, ‘0’ is assigned to “sr_add”. This operation is performed in synchronization with the rising of each clock. FIG. 6B shows a combinational-circuit description converted from the sequential-circuit description shown in FIG. 6A by the sequential-circuit modifier 2. In FIG. 6B, only a genuine arithmetic part is extracted from the original sequential-circuit description shown in FIG. 6A, and “elsif(clk'event and clk=‘1’)”, which is a part for detecting a clock event, is deleted. Signals of “en”, “in1”, and “in2” are written in a sensitivity list (in the parenthesis subsequent to “process”) in order to detect changes in data “en”, “in1”, and “in2”, which are inputs of the combinational-circuit description. With this modification, a wasteful arithmetic operation due to a clock event is not performed and each expression is calculated in response to only a change in the input signal (“en”, “in1”, and “in2”). This can increase the simulation speed.

The simulation describer 3 integrates the combinational-circuit-description part 1b extracted by the circuit separator 1, and the result of the sequential-circuit modifier 2 or the result of the delay adder 6 to generate the simulation description 3a.

Lastly, using the simulation description 3a, the simulation executor 4 executes a simulation.

Now, specific embodiments of the present invention will be described in detail with reference to the accompanying drawings. The same elements throughout the embodiments are denoted by the same reference numerals.

### First Embodiment

The block diagram shown in FIG. 5 also shows a configuration of a simulation apparatus according to a first embodiment of the present invention. Since the functions of the circuit separator 1, the sequential-circuit modifier 2, the simulation describer 3, and the simulation executor 4 have already been described above, the descriptions thereof will be omitted below and more specific operations thereof will be described below.

The simulation apparatus becomes usable, for example, by installing a simulation program on a computer, decompressing and loading the simulation program on a main memory, and causing the CPU (central processing unit) of the computer to execute the simulation program. The computer configured as the simulation apparatus includes, for example, the CPU; a main memory, such as a DRAM (dynamic random access memory); a storage device, such as an HD (hard disk); input devices, such as a keyboard and mouse; and an output device, such as a display.

In the present embodiment, a simulation apparatus having a conversion function for converting an RTL description 1a into a simulation description 3a will be explained. However, a variety of apparatuses may be implemented. The variety includes: an apparatus having only a conversion function (i.e., a model generation device); an apparatus having an HDL editor function and a conversion function; an apparatus having an HDL editor function, a conversion function, and a simulation function; and an apparatus further having a logic synthesizing function.

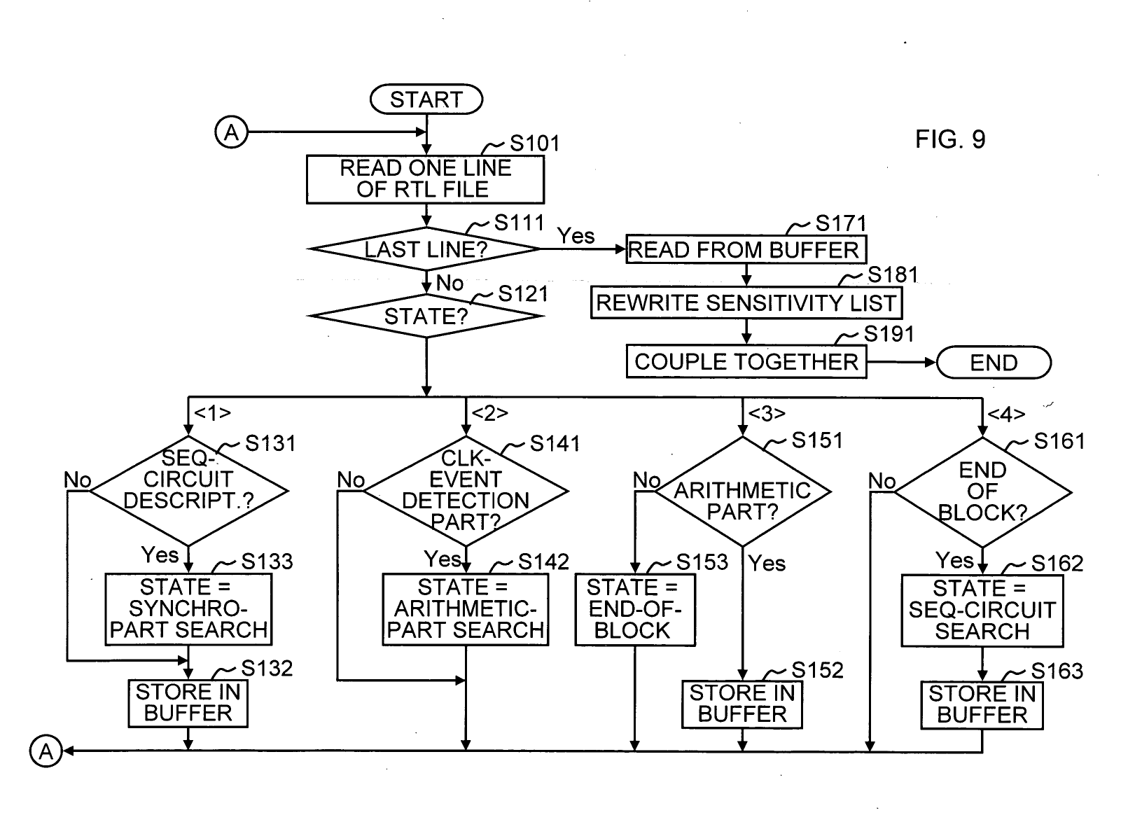

FIG. 9 is a flowchart of a simulation apparatus according to the first embodiment of the present invention. More specifically, FIG. 9 shows a flow for the circuit separator 1, the sequential-circuit modifier 2, and the simulation describer 3 shown in FIG. 5. This flow can be easily realized by, for example, C, C++, or Java®, which is a program language, or awk or Perl, which is a character-string processing language.

Now, a description will be given with reference to the flowchart shown in FIG. 9. Processing in the flow is generally executed by the simulation apparatus and is executed by the CPU from a hardware point of view.

In step S101, the simulation apparatus reads one line of an RTL file. In step S111, the simulation apparatus determines whether or not the read line is the last line of the RTL file. When it is determined in step S111 the read line is not the last line, the simulation apparatus determines a state in step S121. This flow is described as of a state machine which has four states: a sequential-circuit search <1>; a synchronization-part search <2>; an arithmetic-part search <3>; and an end-of-block <4>. The default of the state is the sequential-circuit search <1>.

When it is determined in step S121 that the state is a sequential-circuit search <1>, the circuit separator 1 shown in FIG. 5 separates the RTL file into sequential-circuit descriptions and other descriptions (including combinational-circuit descriptions). In step S131, a determination is made as to whether or not the line of interest is a sequential-circuit description (described as “SEQ-CIRCUIT DESCRIPT.” in FIG. 9). This determination can be achieved on the basis of whether or not a block name containing a predetermined keyword is given to a block statement (e.g., “process” in VHDL or “always” in Verilog-HDL). The block name containing the keyword is given to a sequential-circuit description by the designer. For example, when the block name that includes a keyword “sync” is included as in the case of “sync_{—}0: process”, the block is regarded as a sequential-circuit description. When the circuit separator 1 determines in step S131 that the line of interest is not a sequential-circuit description, the line is stored in a buffer in step S132 and the process returns to step S101. When the circuit separator 1 determines in step S131 that the line of interest is a sequential-circuit description, the state is put into the synchronization-part search <2> (described as “SYNCHRO-PART SEARCH” in FIG. 9) in step S133 and the process proceeds to step S132.

When it is determined in step S121 that the state is a synchronization-part search <2>, the sequential-circuit modifier 2 determines whether or not the line of interest is a clock-event-detection part (described as “CLK-EVENT DETECTION PART” in FIG. 9) in step S141. When it is determined in step S141 that the line of interest is not a clock-event-detection part, the process returns to step S101. When it is determined in step S141 that the line of interest is a clock-event-detection part, the state is put into the arithmetic-part search <3> in step S142 and the process returns to step S101. In the state of the synchronization-part search <2>, the line of interest is not stored in the buffer, and a reset-processing part and the clock-event-detection part in the RTL description are deleted. The clock-event-detection part corresponds to, for example, “elsif(clk'event and clk=‘1’)”.

When it is determined in step S121 that the state is an arithmetic-part search <3>, the sequential-circuit modifier 2 determines whether or not the line of interest is an arithmetic part in step S151. When the line of interest is not an arithmetic part, the state is put into the end-of-block <4> in step S153 and the process returns to S101. When the line of interest is an arithmetic part, the line of interest is stored in the buffer in step S152 and the process returns to step S101. Through the storing of the line of interest in the buffer, the arithmetic part is extracted. The arithmetic part corresponds to, for example, “sr_in1<=in1;”.

When it is determined in step S121 that the state is an end-of-block <4>, the sequential-circuit modifier 2 determines whether or not the line of interest is the end of a block in step S161. When the line of interest is not the end of a block, the process returns to step S101. When the line of interest is the end of a block, the state is put into the sequential-circuit search <1> (described as “SEQ-CIRCUIT SEARCH” in FIG. 9) in step S162. In step S163, the line of interest is stored in the buffer. The end of a block corresponds to, for example, “end process;”.

When it is determined in step S111 that the line of interest is the last line, it means that processing up to the last line of the input RTL file has been finished. Thus, in step S171, the simulation describer 3 reads the RTL description stored in the buffer. In step S181, the simulation describer 3 rewrites a sensitivity list in the sequential-circuit description to convert the sequential-circuit description into a combinational-circuit description. When the description is a sequential-circuit description, the sensitivity list before the rewriting includes a clock or reset. The simulation describer 3 rewrites the sensitivity list into input variables used by an arithmetic part. By doing so, the arithmetic part is executed not at a timing of an input clock signal but at a timing at which the input variable used by the arithmetic part is updated. This makes it possible to considerably reduce the number of arithmetic operations, while keeping necessary operations.

In step S191, the simulation describer 3 couples the rewritten sensitivity list with the other parts. As a result, the combinational-circuit-description part 1b and the combinational-circuit descriptions converted from the sequential-circuit-description part 1c by the sequential-circuit modifier 2 are coupled, so that the entire part (i.e., the simulation description 3a) is constituted by combinational-circuit descriptions.

The simulation description 3a generated by the simulation describer 3, as described above, is executed by the simulation executor 4. This can eliminate the execution of the sequential-circuit description, which execution has, regardless of an algorithm, been performed every time a clock signal is input. Thus, the speed of the simulation can be increased, compared to that in the known technologies.

In this manner, the RTL description is separated into the sequential-circuit-description part 1c and the combinational-circuit-description part 1b, the sequential-circuit-description part 1c is modified and converted into combinational-circuit descriptions, and a simulation description 3a is configured with the combinational-circuit-description part 1b and the combinational-circuit descriptions converted from the sequential-circuit-description part 1c. Thus, this arrangement can provide a simulation description 3a that does not contain a sequential-circuit description which requires an arithmetic operation at each clock event. This arrangement, therefore, provides an advantage in that the simulation description 3a allows the number of arithmetic operations to be reduced. This is because the arithmetic operation during a simulation using the simulation description 3a is triggered by an update of input variables other than a clock variable, rather than being triggered by a clock event.

The input variables are arguments in a block and are written in a sensitivity list.

[Description Checker]

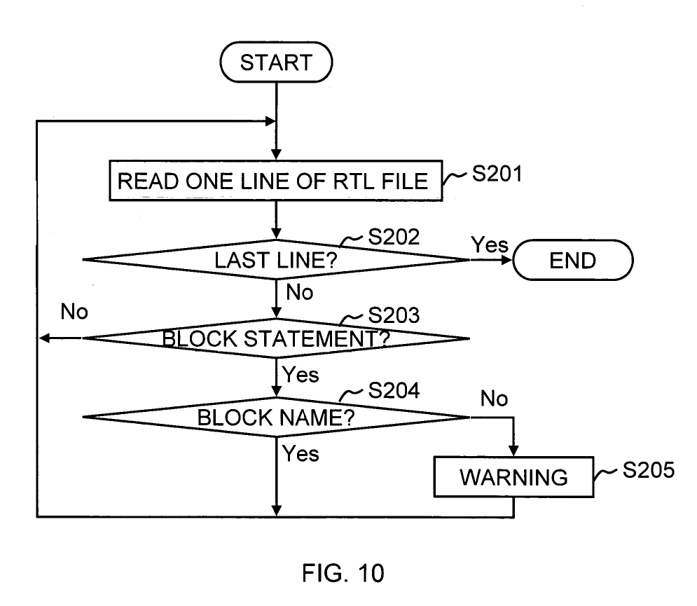

FIG. 10 is a flow chart of the circuit-description checker 5 according to the first embodiment of the present invention.

Before the RTL description 1a is converted into a simulation description 3a, the circuit-description checker 5 checks the RTL description 1a in order to appropriately execute the conversion processing in the present embodiment. In the present embodiment, the circuit-description checker 5 checks whether or not a block name is given to a block statement. For example, in the case of VHDL, when “block_name: process” is written, wherein any character string may be placed for “block_name”, it means that the checking is successful, and when only “process” is written, it means that the checking is unsuccessful and a warning is issued to the user. This checking is executed before the simulation apparatus performs the processing shown in FIG. 9.

In step S201, the circuit-description checker 5 reads one line of the RTL file. In step S202, the circuit-description checker 5 determines whether or not the line of interest is the last line of the RTL file. When it is determined that the line of interest is the last line, the processing of the circuit-description checker 5 ends.

When it is determined in step S202 that the line of interest is not the last line, the circuit-description checker 5 determines whether or not the line of interest is a block statement in step S203. When it is determined in step S203 that the line of interest is not a block statement, the process returns to step S201.

When it is determined in step S203 that the line of interest is a block statement, the circuit-description checker 5 determines whether or not a block name is given to the block statement of the line of interest in step S204. When a block name is given to the block statement, the process returns to step S201. When no block name is given to the block statement, a warning is issued to the user in step S205. One example of issuing the warning is, but not limited thereto, displaying a warning message on a display screen while clearly indicating each warning target or all warning targets. Another warning scheme may also be used.

Since the circuit-description checker 5 performs checking as described above, the above-described conversion processing according to the present embodiment can be appropriately performed.

Thus, in the present embodiment, the circuit-description checker 5 pre-checks whether or not the circuit separator 1 can appropriately separate the RTL description 1a into the sequential-circuit-description part 1c and the combinational-circuit-description part 1b. This arrangement can prevent unwanted model-generation processing from being performed and also can identify a cause thereof. Thus, this arrangement provides an advantage in that, even when a model can be generated, it is possible to prevent the execution of a wasteful simulation due to an inappropriate model.

In the description checking, a determination may be made as to whether or not a name is given to each circuit description contained in the RTL description 1a. In such a case, the user presets, in each circuit description, a name containing a keyword that makes it possible to determine whether the circuit description is a sequential-circuit description or a combinational-circuit description. Examples of the keyword include a character string. A circuit description to which no name is given is extracted and information indicating so is reported to the user.

Giving a name to each circuit description, as described above, allows the model generation device to determine whether the circuit description is a sequential-circuit description or a combinational-circuit description. Alternatively, a keyword, such as a character, character string, or symbol, that makes it possible to determine whether a circuit description of interest is a sequential-circuit description or a combinational-circuit description may be embedded in the circuit description so as to allow the model generation device to determine whether the circuit description is a sequential-circuit description or a combinational-circuit description.

Also, information (e.g., a name of a circuit description) for identifying each circuit description and information indicating whether the circuit description is a sequential-circuit description or a combinational-circuit description may be recorded in association with each other but separately from the circuit description. In this case, the description checking is performed to check whether or not the information is recorded appropriately and separately. Alternatively, such information may be inserted into the header or footer of an RTL description la. In this case, the description checking is performed to check whether or not the information is appropriately inserted into the header or footer.

[Delay Adder]

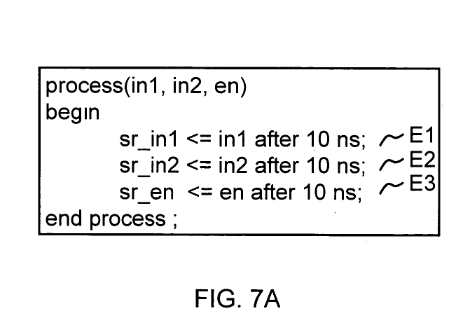

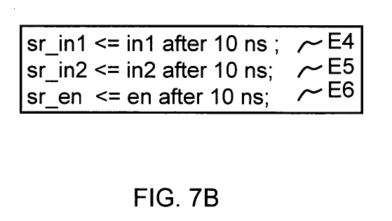

The delay adder 6 shown in FIG. 5 adds a delay time corresponding to the clock period 6a to assignment expressions in the combinational-circuit descriptions converted from the sequential-circuit-description part 1c by the sequential-circuit modifier 2. FIG. 7A is an example of a combinational-circuit description after a delay is added. When it is described in VHDL, the assignment expressions become, e.g. expressions E1, E2, and E3 shown in FIG. 7A. The expression E1 means that, in 10 ns after the value of the signal “in1” changes, the value of “in1” is assigned for the value of the signal “sr_in1”. The time of 10 ns is the delay time corresponding to the clock period 6a. The expressions E2 and E3 are also processed in the same manner. In this description format, unlike a clock-event-based synchronization as shown in FIG. 6A, any wasteful processing is not performed and thus the load of the simulator is reduced. In addition, this means allows timing information inherent in a sequential-circuit description to be incorporated into a combinational-circuit description. Consequently, the output timing of the result of the original RTL description 1a shown in FIG. 5 and the output timing of the result of the simulation description 3a configured according to the present invention completely match each other. Since the delay adder 6 is optional in the present invention, it may be omitted. In such a case, although the result of the arithmetic operation of the simulation description 3a is the same as that of the original RTL description 1a, the output timings of the result is different from that of the original RTL description 1a. Such a scheme is employed when an examiner wishes to know the result of the arithmetic operation as soon as possible.

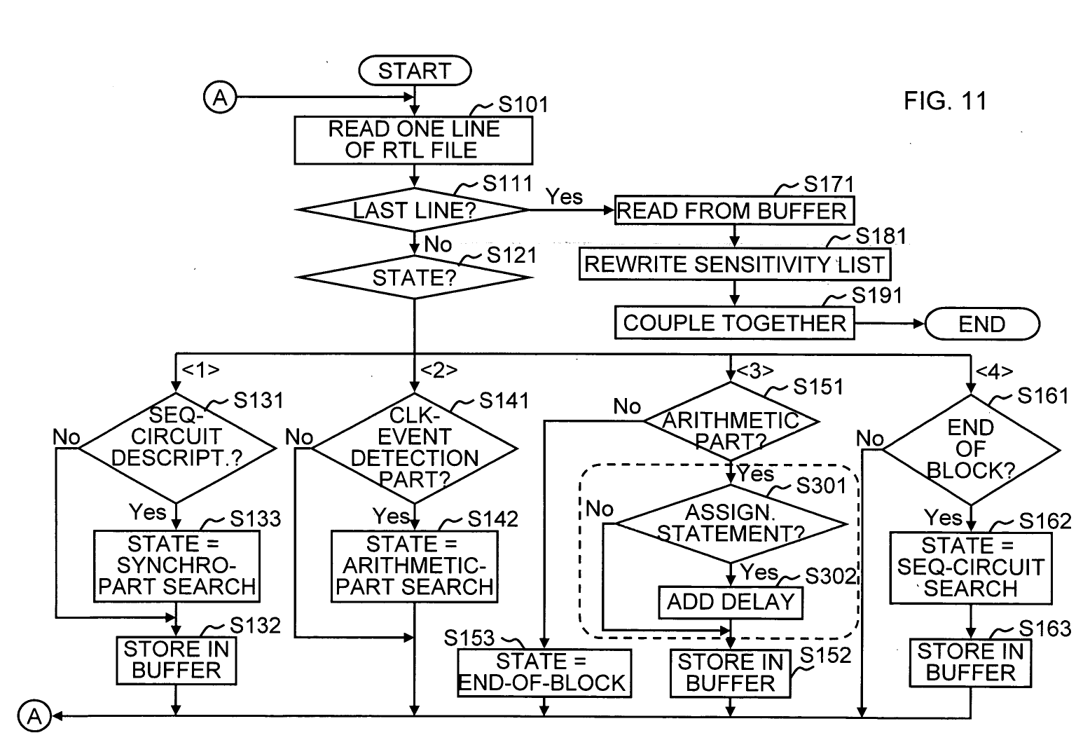

FIG. 11 is a flowchart of a simulation apparatus further including processing performed by the delay adder 6 according to the first embodiment of the present invention. Relative to the flow shown in FIG. 9, the additional processing are surrounded by a broken-line rectangular frame in FIG. 11. The description of the processing illustrated in FIG. 9 will be omitted hereinafter.

Referring to FIG. 11, when it is determined in step S151 that the line of interest is an arithmetic part, the delay adder 6 determines, in step S301, whether or not an assignment statement (described as “ASSIGN. STATEMENT” in FIG. 11) exists in the line of interest, before the buffer storing is performed in S152. When an assignment statement exists in the state of the arithmetic-part search <3>, in step S302, the delay adder 6 adds delay information, i.e., a time corresponding to one period of a clock cycle (e.g., “10 ns” in the case of VHDL), to the assignment statement as shown in FIG. 7A. For processing for non-assignment statements (e.g., loop statements and conditional statements, such as “if” statement and “case” statement), the delay information is not added.

In this manner, adding the delay to assignment processing allows a simulation to be performed at a timing that matches the timing of an original RTL model, even for assignment processing in the converted combinational-circuit description that is not processed using a clock as a trigger.

Thus, in the present embodiment, not only is the sequential-circuit-description part 1c converted into combinational-circuit descriptions but also a delay time is added to an arithmetic expression in the combinational-circuit descriptions. This arrangement provides an advantage in that a simulation can be executed at a timing that matches the timing of the original RTL model. Typically, the delay time to be added corresponds to one period of a clock cycle.

[Optimizer]

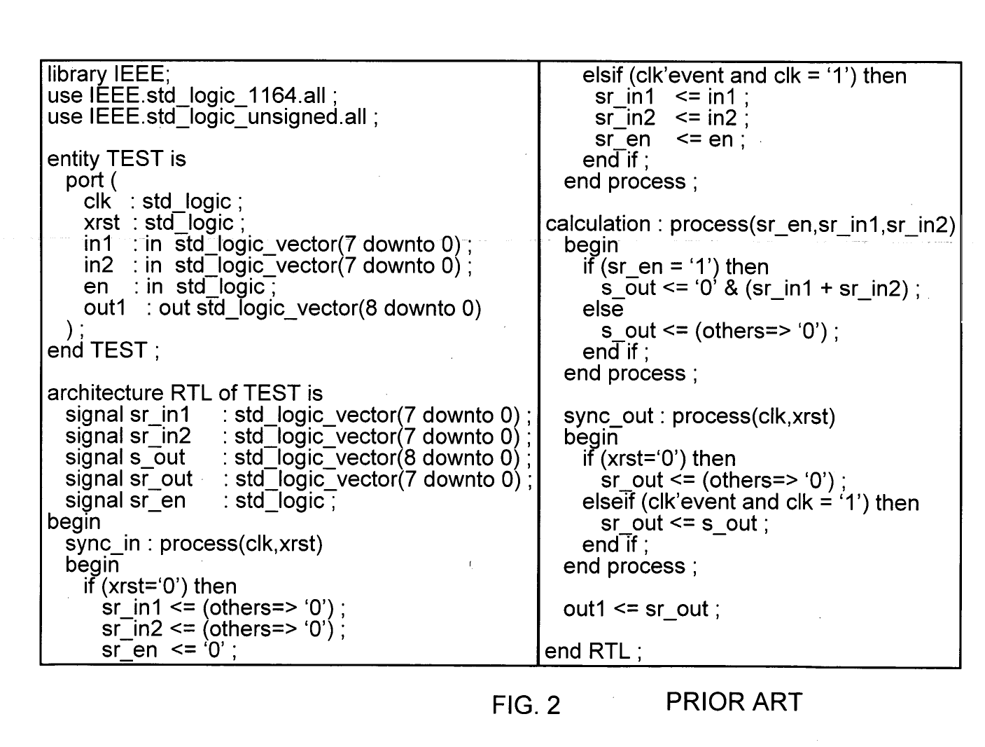

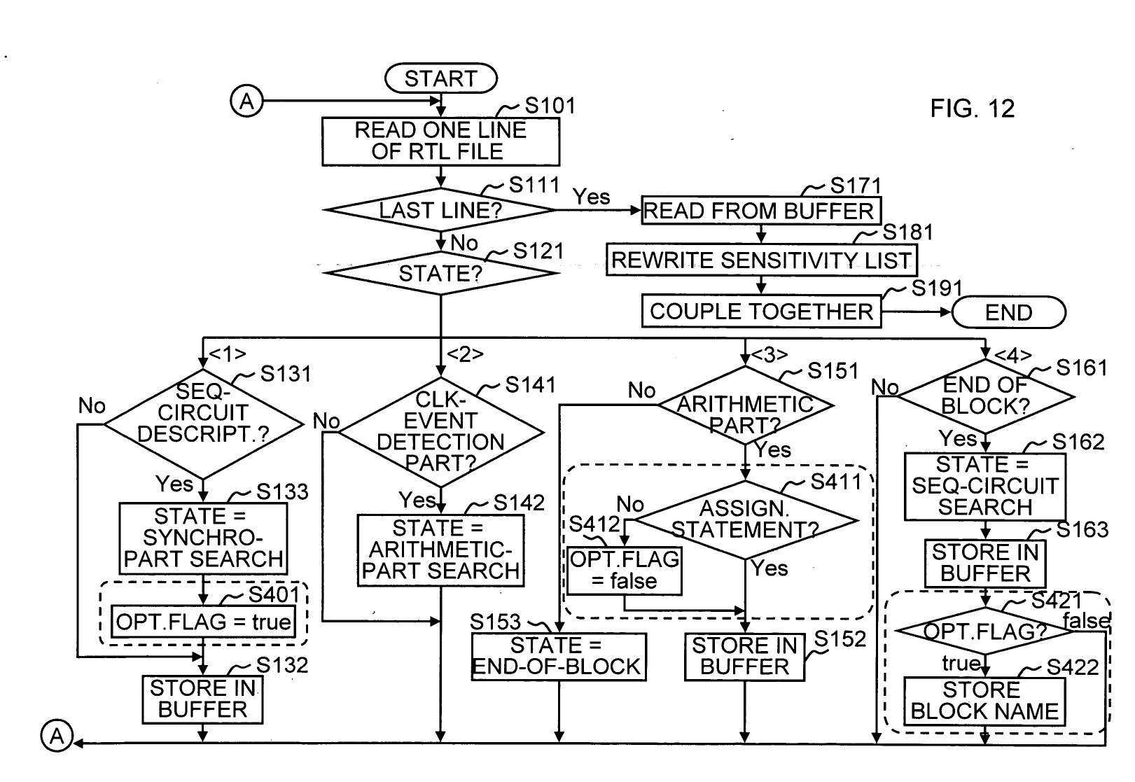

FIG. 12 is a flowchart of a simulation apparatus further including pre-processing for realizing optimizer according to the first embodiment of the present invention. Relative to the flow shown in FIG. 9, the additional processing are surrounded by broken-line rectangular frames in FIG. 12. The additional processing is used to select a sequential-circuit description that can be optimized. The sequential-circuit description that can be optimized in this case is a sequential-circuit description that contains only assignment statements as in the “sync_in” or “sync_out” block shown in FIG. 2. Thus, a block that contains a conditional statement or a control statement is excluded from the optimization. The description of the processing illustrated in FIG. 9 will be omitted hereinafter.

Referring to FIG. 12, after a sequential-circuit description is detected in the state of a sequential-circuit search <1> in step S131 and the state is put into a synchronization-part search <2> in step S133, an initial value “true” is set for an optimization flag (described as “OPT.FLAG” in FIG. 12) in step S401.

Next, when it is determined that the line of interest is an arithmetic part in step S151 described above in the state of arithmetic-part search <3>, a determination is made as to whether or not the line of interest is an assignment statement (described as “ASSIGN.STATEMENT” in FIG. 12) in step S411. When the line of interest is an assignment statement, the value of the optimization flag is kept as it is, namely “true”. When the line of interest is not an assignment statement, it is determined that the block contains a conditional statement or a control statement. Then, in step S412, “false” is set for the optimization flag.

Lastly, after buffer storing is performed in step S163 in the state of the end-of-block <4>, a determination is made in step S421 as to whether the optimization flag is “true” or “false”. When the optimization flag is “true”, it is determined that the sequential-circuit description of interest is to be optimized, and the block name is stored in step S422. When the optimization flag is “false”, it is determined that the block contains a conditional statement or a control statement, and the block name is not stored. The stored block name is used by the optimizer 7, which is described next.

The optimizer 7 shown in FIG. 5 performs optimization on a combinational-circuit description included in the simulation description 3a resulting from the simulation describer 3. The term “optimization” herein refers to replacing a combinational-circuit description that does not contain conditional statements or loop statements and contains only assignment statements with the assignment statements. Thus, the assignment statements become concurrent assignment statements (i.e., assignment statements written outside a block). FIGS. 7A and 7B show an example of the optimization. Three expressions E1, E2, and E3 are written in the combinational-circuit description shown in FIG. 7A. Although the data in the expressions E1, E2, and E3 are independent of each other, the three expressions are always executed when one of “in1”, “in2”, and “en” changes or they change simultaneously. For example, even when the value of “in2” or “en” which is completely irrelevant to the expression E1 in FIG. 7A changes, the expression E1 is executed. The same thing also applies to the expressions E2 and E3. This is wasteful processing and reduces the speed of the simulator. FIG. 7B shows a result obtained by executing the optimizer 7. Although only the “process” statement is deleted from the combinational-circuit description shown in FIG. 7A, expressions E4, E5, and E6 in FIG. 7B operate independently of each other. That is, the expression E4 is not executed when the value of “in2” or “en” changes. The same thing also applies to the expressions E5 and E6. Thus, this scheme can eliminate wasteful processing and can increase the simulation speed.

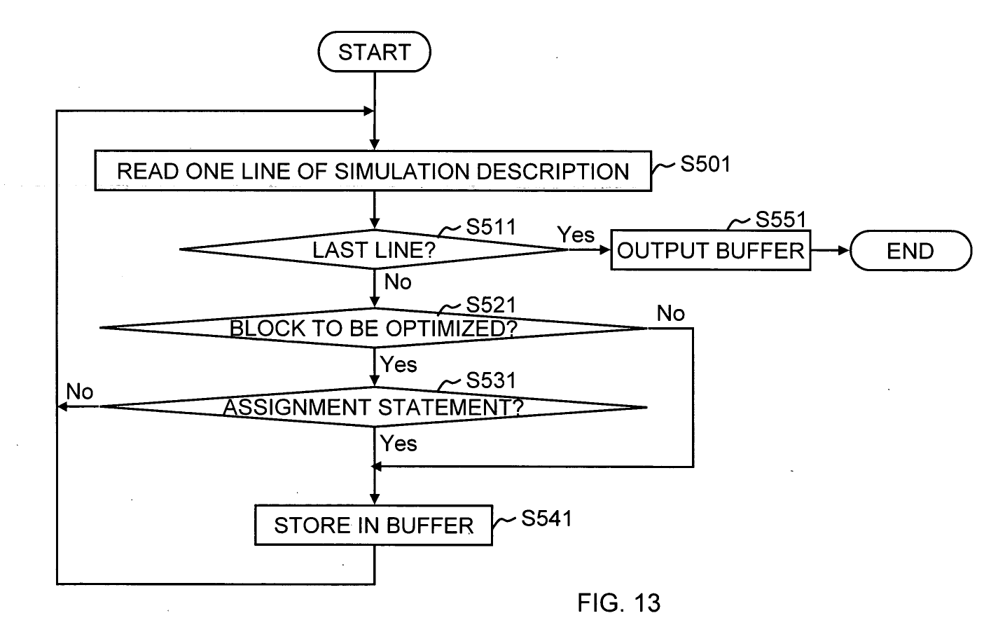

FIG. 13 is a flowchart of the optimizer 7 according to the first embodiment of the present invention. In this flow, the result of the processing in the flow shown in FIG. 12, that is, the result of the simulation describer 3 shown in FIG. 5 is input and the optimizer 7 checks whether or not a block to be optimized is contained in the result. This checking can be performed by using the block name stored in the course of the flow shown in FIG. 12 and performing comparison with the pre-read result of the simulation describer 3. When a block that can be optimized is contained in the result, only assignment statements are stored in the buffer, like as FIG. 7B extracted from FIG. 7A. Parts other than the assignment statements are regarded as unnecessary parts and are not stored in the buffer. Lastly, the parts stored in the buffer are output to thereby complete an optimized simulation description 3a.

More specifically, referring to the flowchart shown in FIG. 13, the simulation apparatus reads, in step S501, one line of the simulation description 3a output from the simulation describer 3.

The simulation apparatus determines whether or not the line of interest is the,last line in step S511.

When it is determined that the line of interest is not the last line in step S511, the optimizer 7 compares the block name stored in step S422 described above with the block name of a block containing the line of interest in step S521, to thereby determine whether or not the block of interest is a block to be optimized. When the block of interest is not a block to be optimized, the line of interest is stored in the buffer in step S541 and the process returns to step S501. When the block of interest is a block to be optimized, the optimizer 7 determines whether or not the line of interest is an assignment statement in step S531. When the line of interest is not an assignment statement, the process returns to step S501. When the line of interest is an assignment statement, the process proceeds to step S541 and the line of interest is stored in the buffer.

In this manner, extracting a block that can be optimized and isolating each line of arithmetic part (this includes, e.g., creating a block that contains an arithmetic part consisting of only one line) allows only the relevant line to be processed when an input variable is updated. This arrangement can eliminate executing of unwanted processing on a line that is irrelevant to a change in value of an input variable.

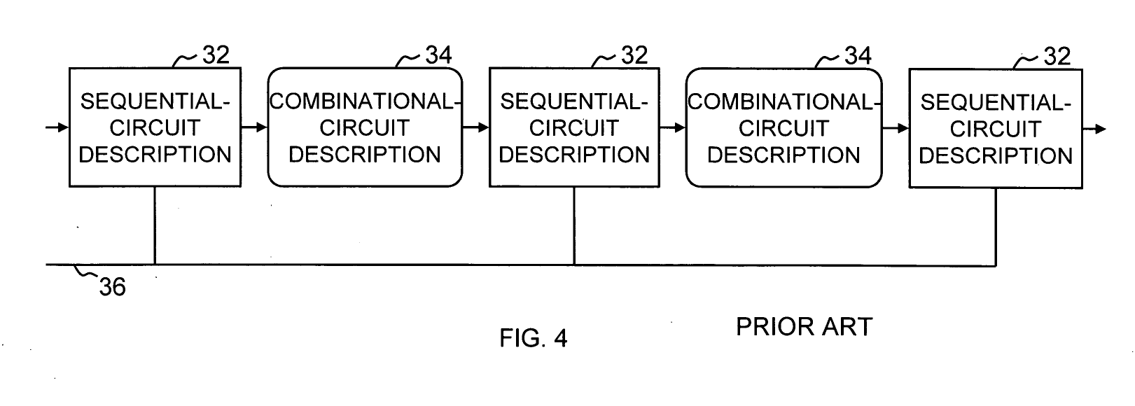

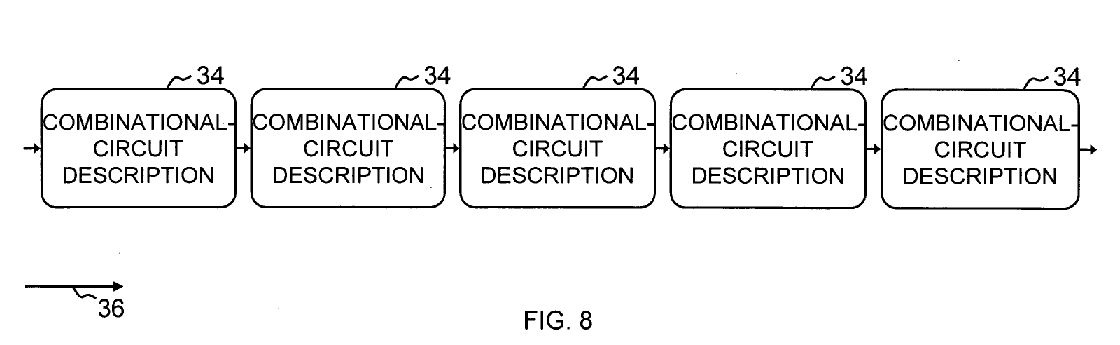

FIG. 8 shows the structure of the simulation description 3a obtained by performing the conversion according to present invention on the typical RTL model shown in FIG. 4. The simulation description 3a contains only combinational-circuit descriptions 34, and no clock is connected thereto. Thus, since the simulation description 3a does not contain any circuit description that reacts to clock events 36, the simulation speed can be increased.

Thus, in the present embodiment, since an arithmetic expression in a combinational-circuit block that satisfies some condition is liberated from the block, the arithmetic expression is independently performed in response to a change in an input variable. This arrangement, therefore, provides an advantage in that only a required arithmetic operation is executed and an unwanted arithmetic operation is not executed.

The optimizer 7 replaces a combinational-circuit description containing an arithmetic part that does not contain a conditional statement with concurrent assignment statements. In the description above, the optimizer 7 performs optimization on the combinational-circuit descriptions converted from the sequential-circuit-description part 1c by the sequential-circuit modifier 2. Alternatively, the optimizer 7 may perform optimization on the combinational-circuit-description part 1b.

As described above, according to the present embodiment, the sequential-circuit descriptions that are processed using a clock event as a trigger are first identified in the RTL description 1a. Further, of the identified sequential-circuit descriptions, processing triggered by the clock event is converted into processing triggered by an update of an input variable other than a clock variable. This arrangement can eliminate processing triggered by a clock event from the RTL description la, so that an arithmetic operation is required only when the input variable is updated. This arrangement, therefore, provides an advantage in that it is possible to obtain a simulation description 3a that can significantly reduce the number of arithmetic operations during simulation.

The keyword for identifying the sequential-circuit descriptions may be a predetermined keyword representing a sequential-circuit description, and the user gives the keyword to a sequential-circuit block as one part of a block name. The keyword for identifying the sequential-circuit descriptions may be a clock variable (“clk'event” or “clk”) used for a condition in a conditional statement or a clock variable in a sensitivity list.

### Second Embodiment

[Sequential-Circuit Detector]

In the first embodiment described above, it is required that the user insert a predetermined character string into a sequential-circuit-description block in an RTL description 1a in advance.

In the configuration description below, the simulation apparatus itself determines whether a circuit description of interest is a sequential-circuit description or a combinational-circuit description in accordance with the contents of the description, and performs sequential-circuit modification on the sequential-circuit description.

A sequential-circuit description inevitably includes conditional branching on a reset event and a clock event. Thus, on the basis of the conditional branching, a sequential-circuit description can be distinguished from a combinational-circuit description.

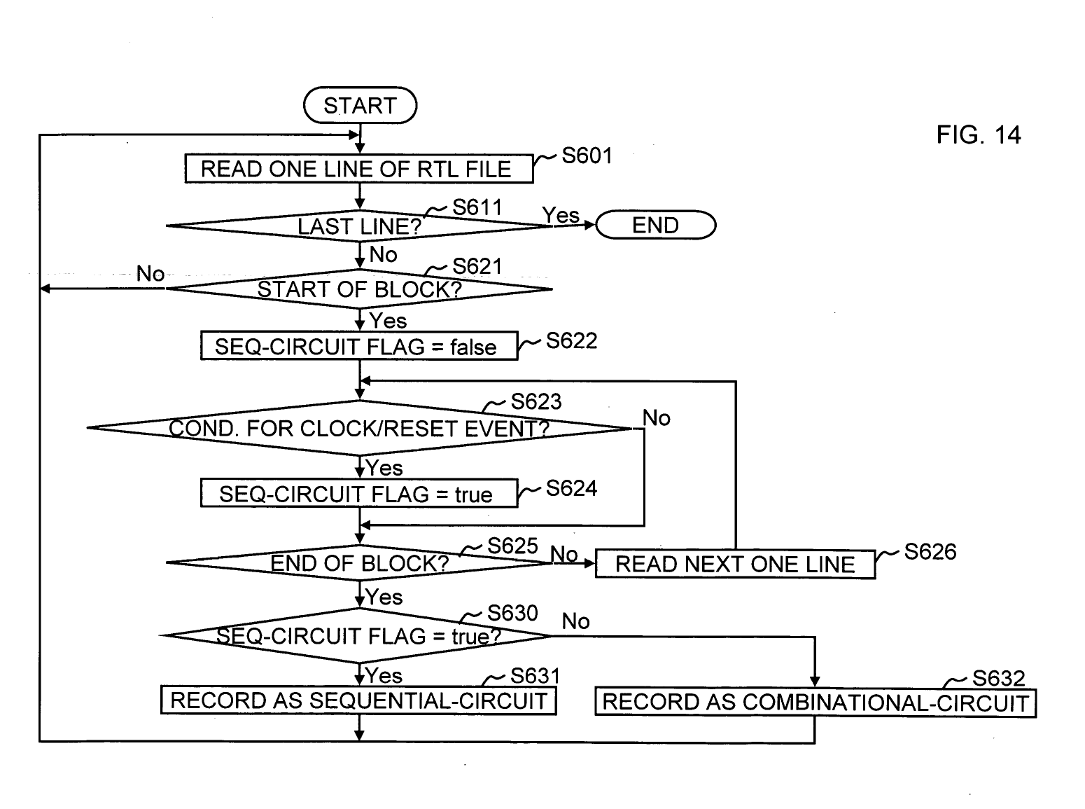

FIG. 14 is a flowchart of the sequential-circuit detector according to a second embodiment of the present invention. This processing performed by the sequential-circuit detector precedes the processing shown in FIG. 9 which is performed by the simulation apparatus.

The simulation apparatus reads, in step S601, one line of the RTL file. In step S611, the simulation apparatus determines whether or not the line of interest is the last line. When it is the last line, the process ends.

When the line of interest is not the last line, the sequential-circuit detector determines, in step S621, whether or not the line of interest is the start of a block. When it is not the start of a block, the process returns to step S601.

When the line of interest is the start of a block, sequential-circuit detector sets “false” (which is an initial value) for a sequential-circuit flag (described as “SEQ-CIRCUIT FLAG” in FIG. 14) in step S622. The sequential-circuit flag is a variable indicating whether or not the line of interest is a sequential-circuit description.

The sequential-circuit detector checks, in step S623, whether or not the line of interest is a conditional statement regarding a clock event or a reset event. When the line of interest is a conditional statement regarding a clock event or a reset event (described as “COND. FOR CLOCK/RESET EVENT” in FIG. 14), the sequential-circuit detector sets “true” for the sequential-circuit flag in step S624. Otherwise, the sequential-circuit detector does nothing.

Next, a determination is made in step S625, as to whether or not the line of interest is the end of a block. When the line of interest is not the end of a block, a next one line is read in step S626.

When the line of interest is the end of a block, a determination is made in step S630, as to whether or not the sequential-circuit flag is “true”. When it is “true”, the block name of the block of interest is recorded in step S631, as the block being a sequential-circuit description. When the sequential-circuit flag is “false”, the block name of the block of interest is recorded in step S632, as the block being a combinational-circuit description.

Recording the name of a sequential-circuit-description block, as described above, allows a determination in step S131 in FIG. 9 to be made on the basis of whether or not the block of interest has the block name of a sequential-circuit description instead of whether or not the block of interest contains a predetermined character string. This arrangement allows the user to eliminate the need to add a character string (which is specified for a sequential-circuit description), when determining the block name.

As described above, the sequential-circuit detector can identify not only the start of a block of a sequential-circuit description but also the end of a block. This makes it possible to record the start of a block and the end of a block of a sequential-circuit description in an RTL description 1a and to perform the sequential-circuit modification only on a sequential-circuit description in the RTL description 1a. Thus, it is possible to significantly reduce an amount of time required for the processing.

Thus, in the present embodiment, before the circuit separator 1 performs the circuit separation, a sequential-circuit description can be detected among from circuit descriptions in an RTL description 1a. This arrangement, therefore, provides an advantage in that a simulation description 3a can be obtained without the user having to giving an instruction for specifying sequential-circuit descriptions, such as giving a block name containing a keyword, to the model generation device.

In this case, for example, when a processing that is triggered by a clock event is contained in a circuit description, the model generation device determines that the circuit description is a sequential-circuit description. More specifically, when a conditional expression that uses a clock variable as a condition is contained in a circuit description or a clock variable is contained in a sensitivity list, the model generation device determines that the circuit description is a sequential-circuit description. Conversely, the arrangement may be such that, when a conditional expression that uses an input variable other than a clock variable as a condition is contained in a circuit description, the model generation device determines that the circuit description is a combinational-circuit description.

### Third Embodiment

[Leaving Reset-Event Processing]

In order to reduce the execution time of a simulation, the first embodiment described above has a configuration for performing processing only when a variable to be subjected to an arithmetic operation changes, without performing arithmetic processing (such as assignment processing) at each clock event in a sequential-circuit description in a block. Further, in the sequential-circuit modification, not only is a clock-event-detection part deleted but also a reset-processing part is deleted. However, a reset-processing part can be left in a sequential-circuit description without being deleted.

The following description is given on the basis of a configuration in which an area to be processed is identified in advance to execute processing, as in the above-described sequential-circuit detector. The configuration, however, may be such that an RTL description 1a is processed line by line, as in the first embodiment.

Since the processing of the start and the end of a sequential-circuit-description block has been described in the explanation of the sequential-circuit detector, the description thereof will be omitted below.

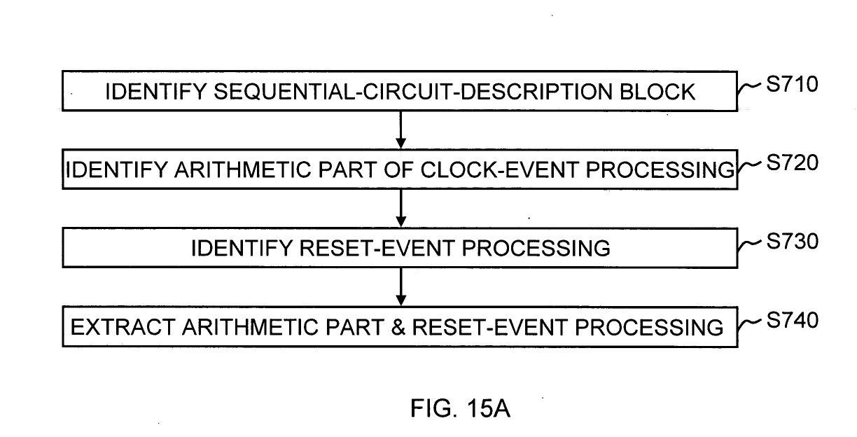

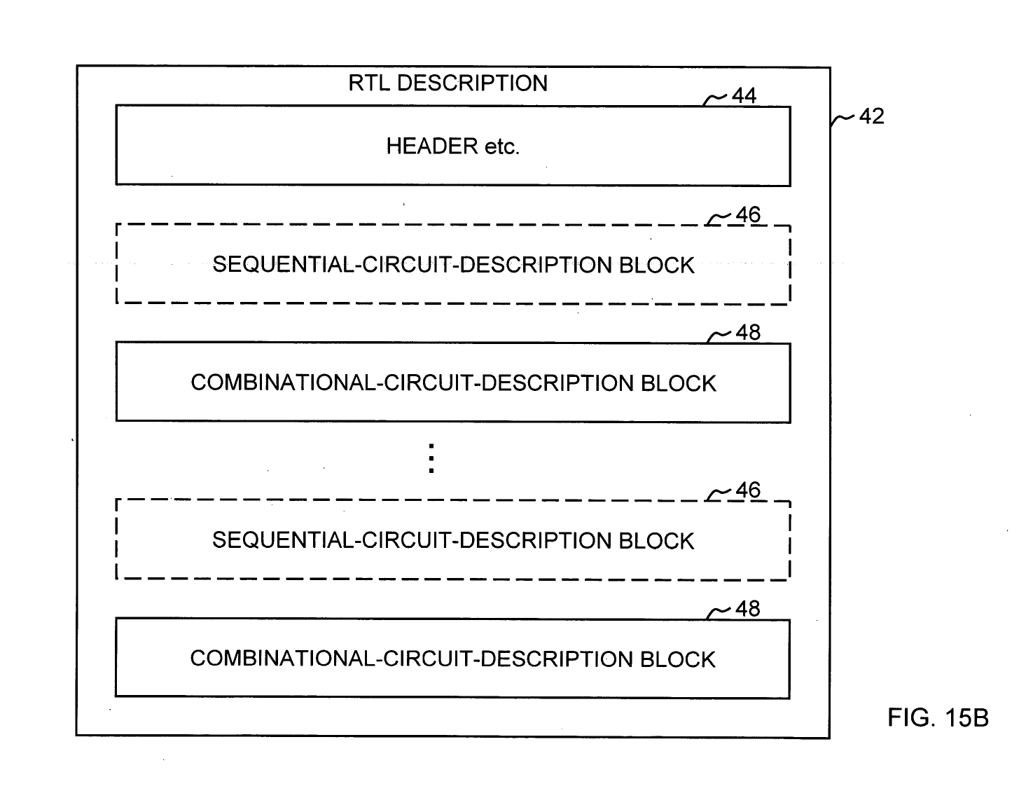

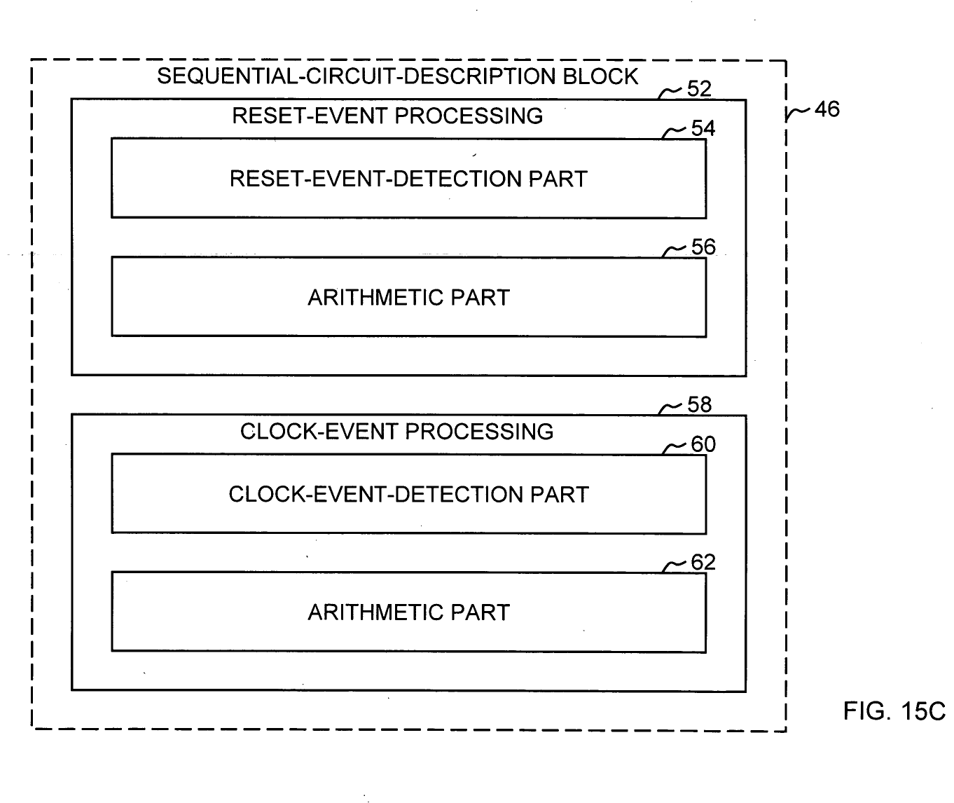

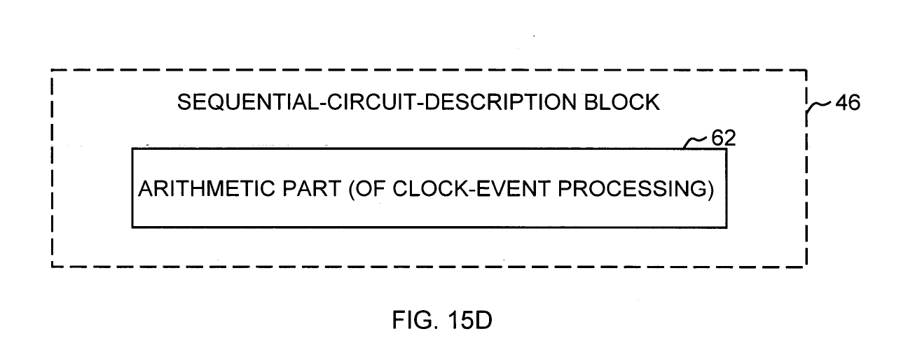

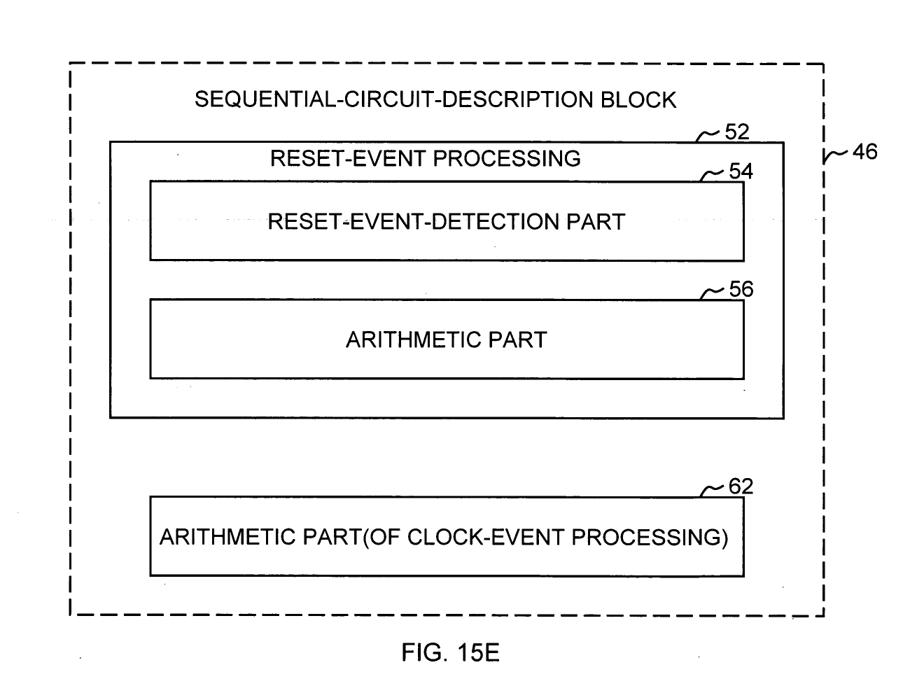

FIG. 15B shows a structure of an RTL description 1a. FIG. 15C shows a structure of a sequential-circuit-description block in the RTL description 1a. As shown in FIG. 15C, a sequential-circuit description block typically contains reset-event processing and clock-event processing. As shown in FIG. 15C, the reset-event processing contains a reset-event-detection part and an arithmetic part, and the clock-event processing contains a clock-event-detection part and an arithmetic part.

In the first embodiment described above, only the arithmetic part of the clock-event processing is extracted from the sequential-circuit-description block, and the reset-event processing and the clock-event-detection part are deleted. In this case, however, the reset-event processing is not deleted but is also left. Even in this case, the clock-event processing is not executed at each clock event, but only the reset-event processing is executed at each reset event, the number of reset events being typically extremely small compared to the number of clock events. Thus, it is possible to execute a simulation that can also deal with reset events, without having much influence on the simulation time, even compared to the first embodiment described above. In the first embodiment, the sequential-circuit-description block is changed from FIG. 15C to FIG. 15D. In the third embodiment, the sequential-circuit-description block is changed from FIG. 15C to FIG. 15E.

FIG. 15A illustrates processing of leaving reset-event processing. In the present embodiment, the sequential-circuit detector identifies a sequential-circuit-description block, in step S710 shown in FIG. 15A. Subsequently, the arithmetic part of clock-event processing is identified and reset-event processing is identified in steps S720 and S730. The reset-event processing can be identified on the basis of a reset-event-detection part. More specifically, the reset-event processing can be identified since it contains an “if” statement or “elsif” statement and also has a variable (a true value) of a clock event as its condition. Although conditions for the identification vary depending on the hardware-description language used, the identification scheme is apparent to those skilled in the art. The arithmetic part of the clock-event processing can be identified as in the first embodiment.

The identified reset event processing and arithmetic part of the clock-event processing are extracted in step S740, and the sequential-circuit-description block is updated. Performing the same processing to all sequential-circuit-description blocks in the RTL description 1a allows a simulation description 3a to be generated.

In this case, since only the reset-event-detection part (e.g., an “if” statement) is left in the sequential-circuit-description block, the arithmetic part of the clock-event processing is also executed at each reset event. Accordingly, it is desired that the arithmetic part of the clock-event processing be enclosed in an “else” statement to prevent the arithmetic part of the clock-event processing from being executed at the time of the reset event.

In the present embodiment, a circuit description to be modified is identified and a modification is made to the identified circuit description to obtain a simulation description 3a. This scheme can also be applied to the first embodiment.

In the embodiments described above, a description is mainly given in the context of a device or apparatus, but it is apparent to those skilled in the art that the present invention can also be implemented as a program or method that can be used for a computer. The present invention can also be implemented in the forms of hardware and/or software. The program can be recorded on any computer-readable medium, such as a hard disk, CD-ROM, DVD-ROM, optical storage device, or magnetic storage device. The program can also be recorded on another computer through a network.

It should be noted that each element of the apparatus according to the present invention can be a single component and also can be a set of components. Furthermore, it should also be noted that a plurality of elements of the apparatus according to the present invention can be a single component. Especially, in case that the apparatus according to the present invention is embodied as a piece of software of a computer, a CPU (central processing unit) of the computer substantially serves as many elements of the apparatus in accordance with the program for causing the computer to execute functions of the elements.

Although the present invention has been described in conjunction with the particular embodiments described above, the present invention can be implemented in various different modes. Thus, the present invention should not be construed on the basis of only the contents described in the embodiments. That is, the technical scope of the present invention is not limited to the embodiments and various modifications and improvements can also be made thereto. An embodiment to which such a modification or improvement is made is also encompassed by the technical scope of the present invention. This is also apparent from the descriptions in the appended claims.

What is claimed is:

1. An apparatus for handling a register-transfer-level description, said register-transfer-level description being described in a hardware-description language and including a sequential-circuit description in which a sequential circuit is described, said sequential circuit having a configuration capable of executing a processing triggered by a clock event, said apparatus comprising:
a circuit separator for separating the register-transfer-level description into a sequential-circuit-description part and a combinational-circuit-description part, said sequential-circuit-description part including the sequential-circuit description, said combinational-circuit-description part not including the sequential-circuit description;
a sequential-circuit modifier for converting the sequential-circuit description included in the sequential-circuit-description part into a combinational-circuit description in which a combinational circuit is described, said combinational-circuit having a configuration capable of executing a processing triggered by an update of an input variable other than a clock variable; and
a simulation describer for configuring a simulation description by coupling the combinational-circuit-description part and the combinational-circuit description converted from the sequential-circuit description included in the sequential-circuit-description part.

2. The apparatus of claim 1, further comprising:
a circuit-description checker for checking the register-transfer-level description as to whether a block name is given to a block statement included in the register-transfer-level description before the circuit separator separates the register-transfer-level description, and for issuing a warning on detecting a block statement which is not given a block name.

3. The apparatus of claim 1, further comprising:
a delay adder for adding a delay time to an arithmetic expression included in the combinational-circuit description converted from the sequential-circuit description included in the sequential-circuit-description part.

4. The apparatus of claim 1, further comprising:
an optimizer for replacing a combinational-circuit description with an assignment statement, said combinational-circuit description being included in the simulation description configured by the simulation describer, said assignment statement being included in the combinational-circuit description.

5. The apparatus of claim 1, further comprising:
a sequential-circuit detector for detecting the sequential-circuit description among from circuit descriptions on the basis of conditional branching included in the circuit descriptions before the circuit separator separates the register-transfer-level description, said circuit descriptions being included in the register-transfer-level description.

6. The apparatus of claim 1, further comprising:
a simulation executor for executing a circuit simulation on the basis of the simulation description configured by the simulation describer.

7. The apparatus of claim 1, wherein
said sequential-circuit modifier removes a clock-event-detection part from the sequential-circuit description, in said clock-event-detection part a description for detecting a clock event being described.

8. A method executed by an apparatus for handling a register-transfer-level description, said register-transfer-level description being described in a hardware-description language and including a sequential-circuit description in which a sequential circuit is described, said sequential-circuit having a configuration capable of executing a processing triggered by a clock event, said method comprising the steps of:
separating the register-transfer-level description into a sequential-circuit-description part and a combinational-circuit-description part, said sequential-circuit-description part including the sequential-circuit description, said combinational-circuit-description part not including the sequential-circuit description;
converting the sequential-circuit description included in the sequential-circuit-description part into a combinational-circuit description in which a combinational circuit is described, said combinational-circuit having a configuration capable of executing a processing triggered by an update of an input variable other than a clock variable; and
configuring a simulation description by coupling the combinational-circuit-description part and the combinational-circuit description converted from the sequential-circuit description included in the sequential-circuit-description part.

9. The method of claim 8, further comprising the step of:
checking the register-transfer-level description as to whether a block name is given to a block statement included in the register-transfer-level description before the register-transfer-level description is separated in the step of separating the register-transfer-level description, and issuing a warning when a block statement which is not given a block name is detected.

10. The method of claim 8, further comprising the step of:
adding a delay time to an arithmetic expression included in the combinational-circuit description converted from the sequential-circuit description included in the sequential-circuit-description part.

11. The method of claim 8, further comprising the step of:
replacing a combinational-circuit description with an assignment statement, said combinational-circuit description being included in the simulation description configured in the step of configuring a simulation description, said assignment statement being included in the combinational-circuit description.

12. The method of claim 8, further comprising the step of:
detecting the sequential-circuit description among from circuit descriptions on the basis of conditional branching included in the circuit descriptions before the register-transfer-level description is separated in the step of separating the register-transfer-level description, said circuit descriptions being included in the register-transfer-level description.

13. The method of claim 8, further comprising the step of:
executing a circuit simulation on the basis of the simulation description configured in the step of configuring a simulation description.

14. The method of claim 8, wherein
in said step of converting the sequential-circuit description, a clock-event-detection part is removed from the sequential-circuit description, in said clock-event-detection part a description for detecting a clock event being described.

15. A program storage medium readable by a computer, said program storage medium storing a program of instructions for the computer to execute method steps of a method for handling a register-transfer-level description, said register-transfer-level description being described in a hardware-description language and including a sequential-circuit description in which a sequential circuit is described, said sequential circuit having a configuration capable of executing a processing triggered by a clock event, said method comprising the steps of:
separating the register-transfer-level description into a sequential-circuit-description part and a combinational-circuit-description part, said sequential-circuit-description part including the sequential-circuit description, said combinational-circuit-description part not including the sequential-circuit description;
converting the sequential-circuit description included in the sequential-circuit-description part into a combinational-circuit description in which a combinational circuit is described, said combinational-circuit having a configuration capable of executing a processing triggered by an update of an input variable other than a clock variable; and
configuring a simulation description by coupling the combinational-circuit-description part and the combinational-circuit description converted from the sequential-circuit description included in the sequential-circuit-description part.

16. The program storage medium of claim 15, said method further comprising the step of:
checking the register-transfer-level description as to whether a block name is given to a block statement included in the register-transfer-level description before the register-transfer-level description is separated in the circuit separating step of separating the register-transfer-level description, and issuing a warning when a block statement which is not given a block name is detected.

17. The program storage medium of claim 15, said method further comprising the step of:
adding a delay time to an arithmetic expression included in the combinational-circuit description converted from the sequential-circuit description included in the sequential-circuit-description part.

18. The program storage medium of claim 15, said method further comprising the step of:
replacing a combinational-circuit description with an assignment statement, said combinational-circuit description being included in the simulation description configured in the simulation-description configuring step of configuring a simulation description, said assignment statement being included in the combinational-circuit description.

19. The program storage medium of claim 15, said method further comprising the step of:
detecting the sequential-circuit description among from circuit descriptions on the basis of conditional branching included in the circuit descriptions before the register-transfer-level description is separated in the circuit separating step of separating the register-transfer-level description, said circuit descriptions being included in the register-transfer-level description.

20. The program storage medium of claim 15, said method further comprising the step of:
executing a circuit simulation on the basis of the simulation description configured in the simulation-description configuring step of configuring a simulation description.
